(19) United States
(12) Patent Application Publication
(10) Pub. No.: US 2022/0413791 A1
(43) Pub. Date: Dec. 29, 2022

(54) INFORMATION PROCESSING SYSTEM, INFORMATION PROCESSING APPARATUS, AND NON-TRANSITORY COMPUTER READABLE MEDIUM STORING INFORMATION PROCESSING PROGRAM

(71) Applicant: FUJIFILM Business Innovation Corp., Tokyo (JP)

(72) Inventor: Kazumoto SHINODA, Kanagawa (JP)

(73) Assignee: FUJIFILM Business Innovation Corp., Tokyo (JP)

(21) Appl. No.: 17/523,924

(22) Filed: Nov. 11, 2021

(30) Foreign Application Priority Data
Jun. 25, 2021 (JP) 2021-105715

(51) Int. Cl. G06F 3/14; H04N 1/00

(52) U.S. Cl. CPC G06F 3/1454; H04N 1/00469; H04N 1/00474; H04N 1/00501

(57) ABSTRACT

An information processing system includes a user terminal including an imaging unit, and a processing apparatus that is operable by the user terminal, in which the processing apparatus includes a first processor, the user terminal includes a second processor, the first processor is configured to display a first operation screen for operating the processing apparatus on a screen of the processing apparatus, the second processor is configured to receive an operation on a second operation screen of the user terminal reflecting the first operation screen captured by the imaging unit and transmit an operation position on the first operation screen corresponding to an operation position of the received operation to the processing apparatus, and the first processor is configured to receive the received operation position as an operation on the first operation screen.

### CROSS-REFERENCE TO RELATED APPLICATIONS

This application is based on and claims priority under 35 USC 119 from Japanese Patent Application No. 2021-105715 filed Jun. 25, 2021.

### BACKGROUND

### (i) Technical Field

The present invention relates to an information processing system, an information processing apparatus, and a non-transitory computer readable medium storing an information processing program.

### (ii) Related Art

JP2011-238006A discloses an image forming system including a server apparatus connected to a network, and an image forming apparatus connected to the network. The image forming apparatus has a display device, and screen data that is used in screen display of the display device. The server apparatus acquires the screen data from the image forming apparatus in a case where a terminal apparatus accesses the server apparatus through the network, generates remote screen data for the terminal apparatus from the screen data and transmits the remote screen data to the terminal apparatus, acquires operation information of a user's operation input to the terminal apparatus during screen display based on the remote screen data from the terminal apparatus and transmits the operation information to the image forming apparatus, and causes the image forming apparatus to execute processing in association with the operation information.

JP2017-208752A discloses an image forming apparatus that enables a remote operation by a communication terminal by way of communication by a relay apparatus. The image forming apparatus includes an operation display unit, a communication unit, and a control unit that controls the operation display unit and the communication unit. The control unit has a remote operation function of providing remote operation screen image information to the outside through the communication unit and enabling a remote operation on the image forming apparatus from the outside by a remote operation screen, transmits the remote operation screen image information associated with a remote operation screen code in advance, to the relay apparatus along with the remote operation screen code, and in displaying a predetermined remote operation screen on the communication terminal, transmits the remote operation screen code corresponding to the remote operation screen image information in the predetermined remote operation screen to the relay apparatus.

### SUMMARY

There are various apparatuses having an operation screen for receiving an operation to execute a certain function. For example, an image forming apparatus executes processing in a case where a user directly operates an operation screen provided in the image forming apparatus.

Recently, there is a demand that a user does not want to touch and operate the operation screen touched by an unspecified large number of users touch from a viewpoint of infection prophylaxis. A structure in which the user remotely operates the image forming apparatus from a limited terminal has already been provided. However, in a case of an operation from a remote location, since a user who remotely operates the image forming apparatus is not in front of the image forming apparatus, the user cannot recognize that another user is in use the image forming apparatus, and there is a possibility that another user directly touches and operates the operation screen of the image forming apparatus at the same timing.

Aspects of non-limiting embodiments of the present disclosure relate to an information processing system, an information processing apparatus, and a non-transitory computer readable medium storing an information processing program that enable reception of an operation from a user while making another user recognize that an apparatus is in use without needing for a user to directly touch an operation screen provided in the apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system includes a user terminal including an imaging unit, and a processing apparatus that is operable by the user terminal, in which the processing apparatus includes a first processor, the user terminal includes a second processor, the first processor is configured to display a first operation screen for operating the processing apparatus on a screen of the processing apparatus, the second processor is configured to receive an operation on a second operation screen of the user terminal reflecting the first operation screen captured by the imaging unit and transmit an operation position on the first operation screen corresponding to an operation position of the received operation to the processing apparatus, and the first processor is configured to receive the received operation position as an operation on the first operation screen.

### BRIEF DESCRIPTION OF THE DRAWINGS

Exemplary embodiment(s) of the present invention will be described in detail based on the following figures, wherein:

FIG. 1 is a diagram showing the schematic configuration of an information processing system 1;

FIG. 2 is a diagram showing an example of first operation screen and second operation screen display;

FIG. 3 is a block diagram showing the hardware configuration of a processing apparatus 10;

FIG. 4 is a block diagram showing the hardware configuration of a user terminal 20;

FIG. 5 is a block diagram showing the functional configuration of the processing apparatus 10 and the user terminal 20;

FIG. 6 is a diagram showing an example of a recognition method of the first operation screen by the user terminal 20;

FIG. 7 is a diagram showing an example of coordinate information on the first operation screen and the second operation screen;

FIG. 8 is a diagram showing an example where an operation on the processing apparatus 10 is received through an operation on the second operation screen;

FIG. 9 is a sequence diagram representing a relationship between the processing apparatus 10 and the user terminal 20;

FIG. 10 is a diagram showing an example of correcting the second operation screen;

FIG. 11 is a diagram showing another example of first operation screen and second operation screen display;

FIG. 12 is a diagram showing an example of trimming the second operation screen; and

FIG. 13 is a diagram showing an example of enlarging the second operation screen.

### DETAILED DESCRIPTION

Hereinafter, an example of an exemplary embodiment according to the technique of the disclosure will be described in detail referring to the drawings.

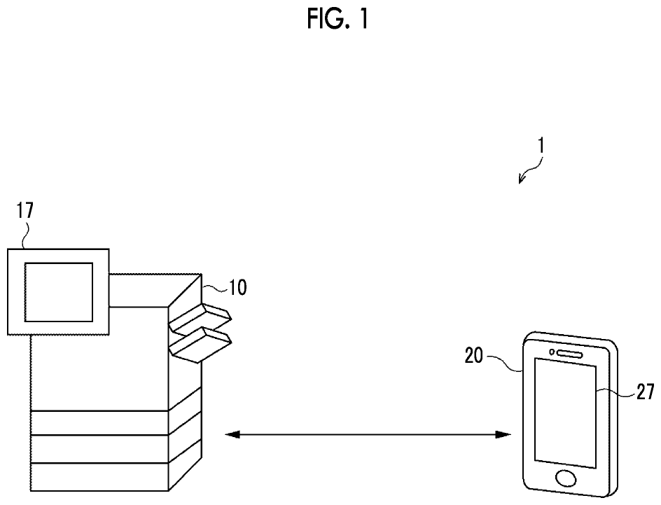

FIG. 1 is a diagram showing the schematic configuration of an information processing system 1 according to the exemplary embodiment.

As shown in FIG. 1, the information processing system according to the exemplary embodiment includes a processing apparatus 10, and a user terminal 20 that can operate the processing apparatus 10.

The processing apparatus 10 is an apparatus having an operation screen for receiving an operation to execute a certain function, and as shown in FIG. 1, the processing apparatus 10 includes a display unit 17 that displays the operation screen for receiving an operation to execute a certain function. An example of the processing apparatus 10 in the exemplary embodiment is an image forming apparatus, and provides various image forming functions, such as print, copy, and facsimile, in a case where the user operates the operation screen displayed on the display unit 17.

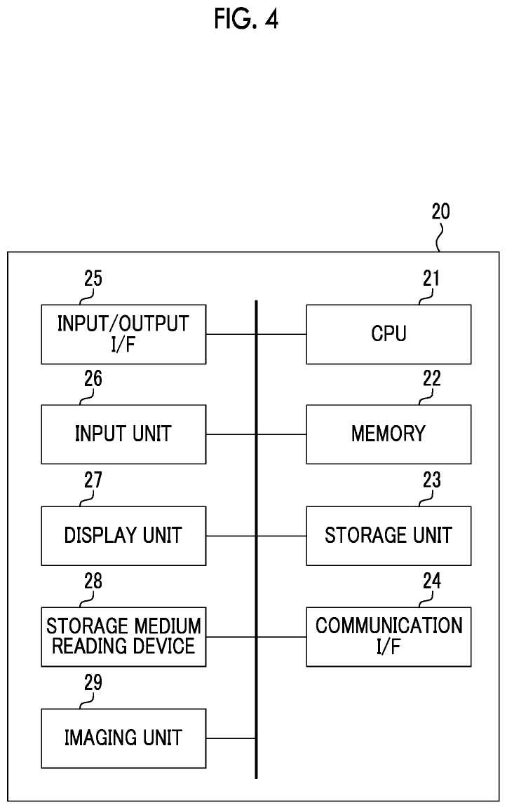

As shown in FIG. 1, the user terminal 20 is a terminal that includes a display unit 27, such as a display, and is used by a limited user, and is represented by a smartphone in the exemplary embodiment. The user terminal 20 may be a tablet type portable terminal other than the smartphone. The user terminal 20 further includes an imaging unit 29 that is an imaging unit, such as a camera (see FIG. 4).

As shown in FIG. 1, the processing apparatus 10 is connected to the user terminal 20 in a communicable manner. Though not shown, such apparatuses are connected to a network, and can perform communication with each other through the network. As the network, as an example, the Internet, a local area network (LAN), or a wide area network (WAN) is applied. The processing apparatus 10 and the user terminal 20 may be connected in pairing by a wireless communication technique, such as Bluetooth (Registered Trademark), depending on a timing to use.

Mutual connection of the processing apparatus 10 and the user terminal 20 will be described. First, the processing apparatus 10 displays an access destination for enabling connection with the user terminal 20 as an external apparatus on the display unit 17. Examples of display means of the access destination for enabling connection with the user terminal 20 include a QR code (Registered Trademark). In the display of the access destination of the processing apparatus 10, an access destination uniform resource locator (URL) or the like is set in advance.

The user terminal 20 acquires the access destination displayed on the display unit 17 using the imaging unit 29 and accesses the designated access destination. As a result of the user terminal 20 accessing the designated access destination, in a case where determination is made that the user terminal 20 is a terminal, connection of which is permitted in advance in the processing apparatus 10, the processing apparatus 10 issues, for example, a token as identification information for connection. The identification information for connection may be information that is used for user identification and session management for use in Cookie or the like.

In mutual communication after the issuance of the identification information for connection, the processing apparatus 10 verifies the identification information for connection included in access information with respect to access, such as an operation request from the user terminal and authenticates whether or not the identification information for connection is identification information for connection regularly issued by the processing apparatus 10. In mutual communication between the user terminal 20 and the processing apparatus 10 after first access, permission of communication is mutually certificated by including the identification information for connection issued by the processing apparatus 10, and communication is safely performed.

Accordingly, in a case where determination is made that the user terminal 20 that is an access source is a terminal, connection of which is not permitted in the processing apparatus 10, the processing apparatus 10 does not issue the identification information for connection, and the user terminal 20 can perform communication with the processing apparatus 10.

In ending mutual communication between the processing apparatus 10 and the user terminal 20, the processing apparatus 10 or the user terminal 20 receives an operation, such as explicit logout by the user. Alternatively, mutual communication is ended by reset of permission of mutual communication in a case where a predetermined time elapses in a state in which any operation is not performed in the processing apparatus 10 or the user terminal 20. The processing apparatus 10 discards the identification information for connection at the timing when the logout or the reset is received.

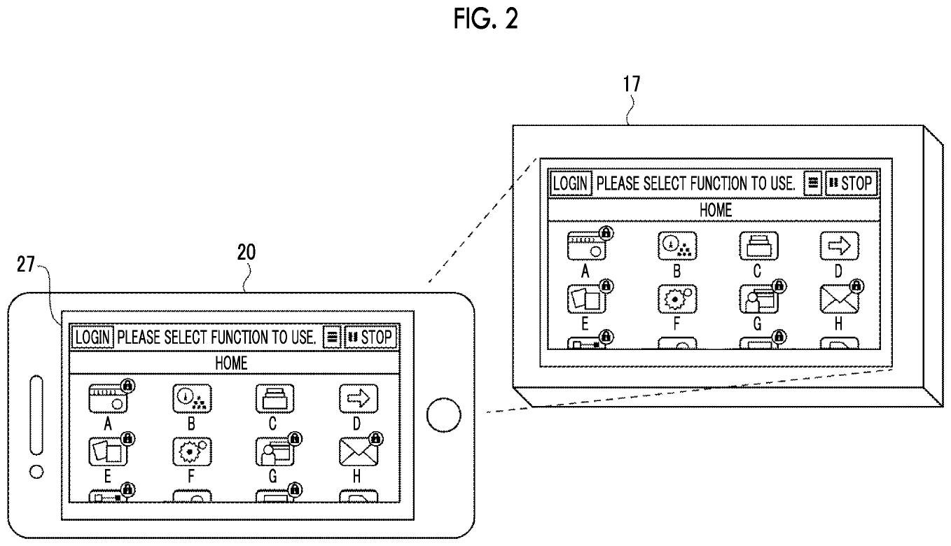

FIG. 2 is a diagram showing an example of first operation screen and second operation screen display.

The first operation screen is an operation screen that is displayed on the display unit 17 of the processing apparatus 10 for receiving an operation to execute a function of the processing apparatus 10. The processing apparatus 10 receives execution of processing in a case where the user directly operates the operation screen displayed on the display unit 17 provided in the processing apparatus 10. In the example of FIG. 2, the functions of the processing apparatus 10 are displayed by icons as a function name “A”, a function name “B”, a function name . . . , a function name “H”, and the like on the first operation screen.

The second operation screen is a screen that is displayed on the display unit 27 of the user terminal 20, and is an operation screen that displays the first operation screen captured by the imaging unit 29 in the user terminal 20 on the display unit 27 and receives an operation on the processing apparatus 10 from the user. In the example of FIG. 2, like the display of the first operation screen, the functions of the processing apparatus 10 are displayed by icons as a function name “A”, a function name “B”, a function name “C”, . . . , a function name “H”, and the like on the second operation screen.

The information processing system 1 according to the exemplary embodiment receives an operation on the second operation screen as an operation on the processing apparatus 10, thereby receiving an operation on the processing apparatus 10 without needing for the user to directly touch the display unit 17 provided in the processing apparatus 10. In the information processing system 1 according to the exemplary embodiment, since the user performs an operation on the processing apparatus 10 on the user terminal 20 near the processing apparatus 10 while capturing the first operation screen by the imaging unit 29, another user easily recognizes that the processing apparatus 10 is in use.

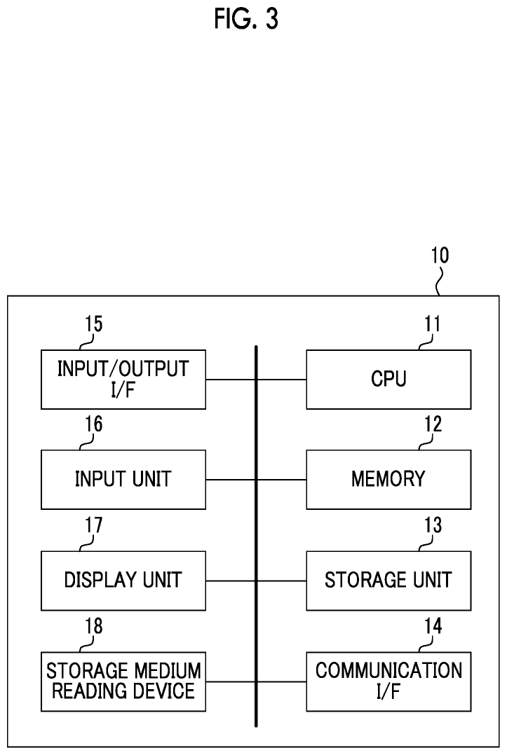

Next, the hardware configurations of the processing apparatus 10 and the user terminal 20 according to the exemplary embodiment will be described. FIG. 3 is a block diagram showing the hardware configuration of the processing apparatus 10 according to the exemplary embodiment, and FIG. 4 is a block diagram showing the hardware configuration of the user terminal 20 according to the exemplary embodiment.

As shown in FIG. 3, the processing apparatus 10 has a central processing unit (CPU) 11, a memory 12, a storage unit 13, a communication interface (I/F) 14, an input/output I/F 15, an input unit 16, a display unit 17, and a storage medium reading device 18. The processing apparatus 10 has a hardware configuration necessary for execution of various kinds of processing, such as image forming. In the exemplary embodiment, the hardware configuration necessary for execution of various kinds of processing is not shown.

The CPU 11 is a central arithmetic processing unit, executes various programs, and controls each configuration. That is, the CPU 11 reads programs from the storage unit 13 and executes the programs with the memory 12 as a work area. The CPU 11 controls each configuration described above and executes various kinds of arithmetic processing in association with the programs stored in the storage unit 13 or the like.

The memory 12 is configured with a random access memory (RAM), and temporarily stores programs and data as a work area.

The storage unit 13 is configured with a read only memory (ROM), a hard disk drive (HDD), or a solid state drive (SSD), and stores various programs including an operating system and various kinds of data.

The communication I/F 14 is an interface for communication with other equipment, and, for example, a standard, such as Ethernet (Registered Trademark), FDDI, or Wi-Fi (Registered Trademark), is used. A standard, such as Bluetooth (Registered Trademark), may be used.

The input/output I/F 15 is an interface that connects the processing apparatus 10 and external equipment.

The input unit 16 is, for example, a configuration for performing various inputs, such as a keyboard or a mouse operation. In a case where an input is a tap operation to the display unit 17 as a touch panel, the display unit 17 may be used as the input unit 16.

The display unit 17 is, for example, a liquid crystal display and displays various kinds of information. The display unit 17 may employ a touch panel system to function as the input unit 16.

The storage medium reading device 18 performs reading of data stored in various storage mediums, such as a compact disc (CD)-ROM, a digital versatile disc (DVD)-ROM, a Blu-ray disc, and a universal serial bus (USB) memory, or writing of data to the storage mediums.

FIG. 4 is a block diagram showing the hardware configuration of the user terminal 20 according to the exemplary embodiment. Description of the hardware configuration of the user terminal 20 overlapping the hardware configuration of the processing apparatus 10 described above will not be repeated. As described above, the user terminal 20 includes the imaging unit 29 as the hardware configuration. The imaging unit 29 is a camera function or the like, and a configuration for capturing the first operation screen displayed on the display unit 17.

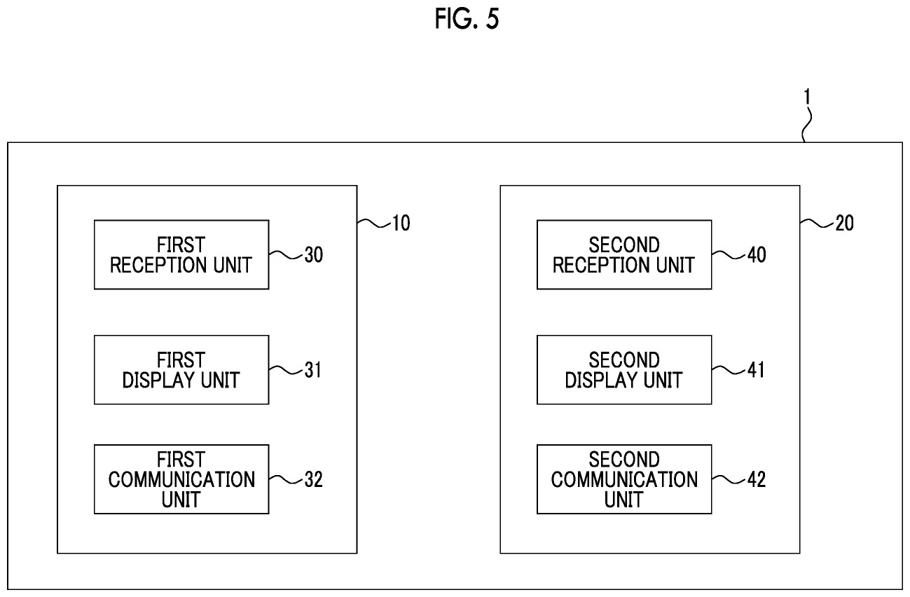

Next, the functional configuration of the information processing system 1 according to the exemplary embodiment will be described. FIG. 5 is a block diagram showing the functional configuration of the information processing system 1.

As shown in FIG. 5, the information processing system includes functional configurations in each of the processing apparatus 10 and the user terminal 20. As the functional configurations of the processing apparatus 10 and the user terminal 20, a first reception unit 30, a first display unit 31, and a first communication unit 32 are included in the processing apparatus 10, and a second reception unit 40, a second display unit 41, and a second communication unit 42 in the user terminal 20. Each functional configuration is realized by the CPU 11 of the processing apparatus 10 or the CPU 21 of the user terminal 20 cooperating with each hardware configuration.

The first display unit 31 displays the first operation screen for receiving an operation to the processing apparatus 10 on the screen of the display unit 17. In this case, the first display unit 31 also displays marks for the user terminal 20 to analyze a position and a size of the first operation screen at four corners on the first operation screen simultaneously with the display of the first operation screen. Hereinafter, the marks displayed on the first operation screen for the user terminal 20 to analyze the position and the size of the first operation screen are expressed as “marks”.

The second display unit 41 displays the first operation screen captured using the imaging unit 29 as the second operation screen on the display unit 27.

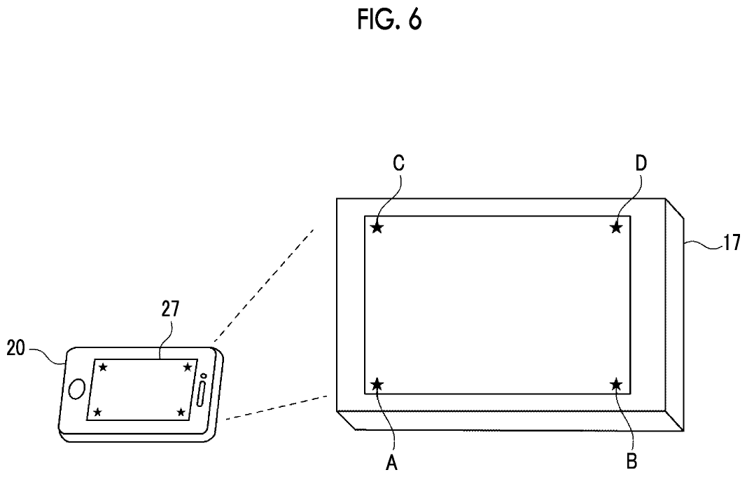

FIG. 6 is a diagram showing an example of a recognition method of the first operation screen by the user terminal 20. In a case where the user captures the first operation screen using the imaging unit 29, the second reception unit 40 specifies the four corners of the first operation screen by the imaging unit 29 and receives the position and the size of the first operation screen. The second reception unit 40 receives that the entire first operation screen is captured in a case where all corners of the first operation screen captured by the imaging unit 29 are confined within the screen of the display unit 27.

The marks are displayed at the four corners of the first operation screen displayed on the display unit 17 by the first display unit 31. As shown in FIG. 6, in the exemplary embodiment, the marks are at positions that are represented by star symbols at the four corners on the first operation screen. The star symbols as the marks shown in FIG. 6 are displayed for convenience accompanied with the description, and symbols, such as stars, do not need to be displayed at the four corners on the first operation screen such that the user can actually recognize the marks. In this case, the marks may be fitted to four corners or four sides of an outer frame of a liquid crystal part or the like. The marks may be embedded information or the like that can be detected by the user terminal 20.

As shown in FIG. 6, for example, the four corners of the first operation screen are denoted as a corner A on a lower left side of the display unit 17, a corner B on a lower right side, a corner C on an upper left side, and a corner D on an upper right side. In a case where an image where all corners of the corner A to the corner D are confined within the screen of the display unit 27 is captured by the imaging unit 29, the second reception unit 40 receives the inside of a rectangular frame formed by connecting the marks at all the four corners of the corner A to the corner D by lines as the first operation screen from the captured image. The second display unit 41 displays the first operation screen received by the second reception unit 40 on the display unit 27.

The second communication unit 42 transmits an operation position on the first operation screen corresponding to an operation position of the received operation to the processing apparatus 10. The second communication unit 42 transmits coordinate information with an operation position of an operation of the user on the second operation screen as the operation position on the first operation screen. The first communication unit 32 receives the coordinate information from the user terminal 20.

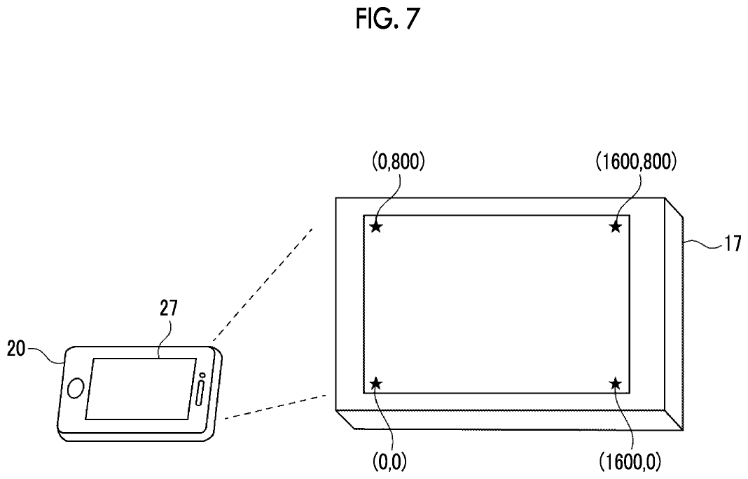

FIG. 7 is a diagram showing an example of the coordinate information on the first operation screen and the second operation screen. The second reception unit 40 receives the size of the first operation screen captured by the imaging unit 29 based on the positions of the marks. In the example of FIGS. 6 and 7, in a case where a longitudinal direction of the display unit 17 and the display unit 27 is X and a transverse direction is Y to define coordinates (X,Y), it is assumed that the size of the second operation screen is a coordinate region of (0,0) to (640,480), and the size of the first operation screen is a coordinate region of (0,0) to (1600,800). The second reception unit 40 receives coordinate information that the corner B is at a position of (1600,0), the corner C is at a position of (1600,800), and the corner D is at a position of (0,800) with the corner A(0,0) on the first operation screen as a starting point. Hereinafter, the corner A(0,0) on the first operation screen is expressed as a “panel origin”.

The second reception unit 40 receives an operation of the user on the second operation screen. The second communication unit 42 transmits a coordinate position on the first operation screen calculated from a relative ratio to a coordinate position on the second operation screen on an operation position of the operation received by the second reception unit 40 to the processing apparatus 10.

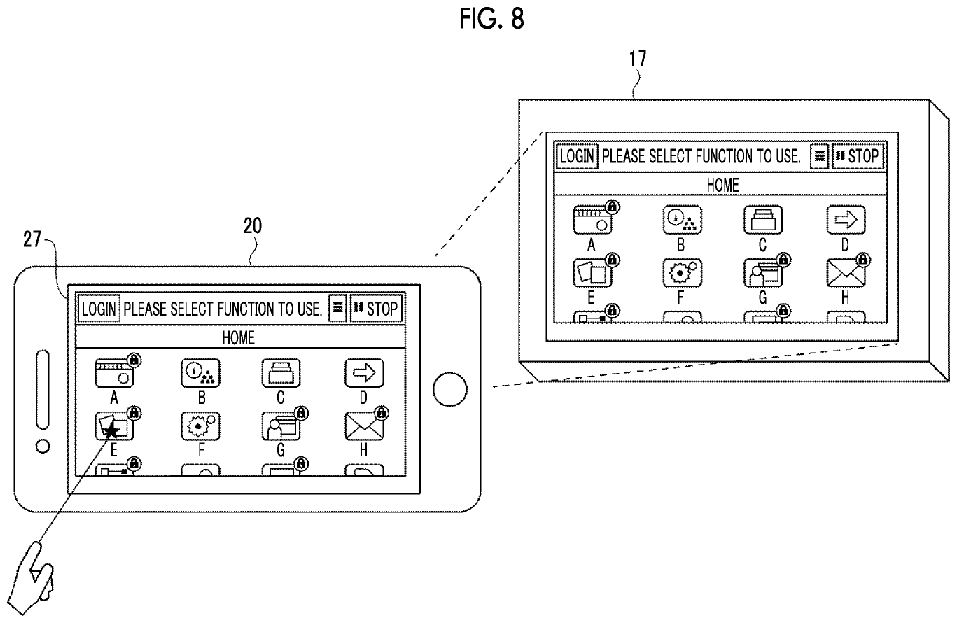

FIG. 8 is a diagram showing an example of receiving an operation by an operation on the second operation screen. A place indicated by a star symbol with a line connected to a fingertip of the user on the user terminal 20 on a left side of FIG. 8 is a place of an icon tapped by the user. In the example of FIG. 8, the user taps the icon of the function name “E” on the second operation screen.

The second reception unit 40 receives the position of the icon of the function name “E” on the second operation screen tapped by the user as an operation position. Specifically, the second reception unit 40 receives the position of the icon of the function name “E” on the second operation screen tapped by the user as the coordinates.

The example of FIG. 8 will be described using the example of FIGS. 6 and 7. In FIG. 8, it is assumed that the position of the icon of the function name “E” tapped by the user on the second operation screen is the position of (200,120) on the second operation screen with the panel origin as a starting point. The second reception unit 40 receives the position of (200,120) on the second operation screen as the position of the icon tapped by the user.

The second communication unit 42 first calculates the operation position of the operation received by the second reception unit 40 as a coordinate position on the first operation screen from a relative ratio to a coordinate position on the display unit 27. The size of the second operation screen is (640,480), and the position of the icon tapped by the user is the position of (200,120) on the second operation screen with the panel origin as a starting point. The second communication unit 42 calculates a position of (200/640,120/480) to the size of the second operation screen with the panel origin as a starting point, that is, at a ratio of (0.3125,0.25) from the panel origin as the coordinate position on the first operation screen. In the above-described example, a position having a ratio of (0.3125,0.25) to the first operation screen having a screen size of (1600,800) is (1600*0.3125,800*0.25), that is, (500,200). The second communication unit 42 transmits the coordinates (500,200) in the first operation screen as the operation position of the operation of the user.

The first reception unit 30 receives information regarding the operation position on the first operation screen received from the second communication unit 42 as the coordinates. As shown in FIG. 8, the icon of the function name “E” is present in the coordinates (500,200) of the first operation screen. Accordingly, the first reception unit 30 receives the icon of the function name “E” as the operation position on the first operation screen like the icon on the second operation screen.

In this way, in the information processing system 1 according to the exemplary embodiment, the second communication unit 42 transmits the operation position calculated from the ratio in the coordinates to the operation position on the second operation screen as the position in the coordinates on the first operation screen to the processing apparatus 10.

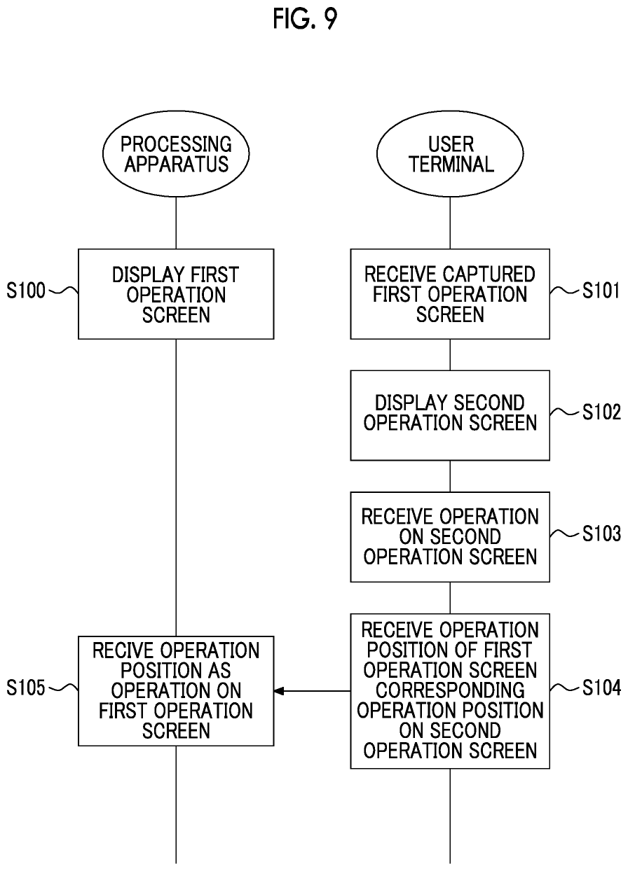

FIG. 9 is a sequence diagram representing a relationship between the processing apparatus 10 and the user terminal 20. Interaction between the processing apparatus 10 and the user terminal 20 will be described along FIG. 9. Processing of the information processing system 1 according to the exemplary embodiment is implemented by the CPU 11 reading and executing an information processing program stored in the storage unit 13 or the like and the CPU 21 reading and executing the information processing program stored in the storage unit 23 or the like.

In Step S100, the CPU 11 displays the first operation screen on the display unit 17, as the first display unit 31.

In Step S101, the CPU 21 receives information regarding the first operation screen captured by the imaging unit 29, as the second reception unit 40.

In Step S102, the CPU 21 displays the first operation screen received in Step S101 as the second operation screen on the display unit 27, as the second display unit 41.

In Step S103, the CPU 21 receives an operation of the user on the second operation screen displayed in Step S102, as the second reception unit 40.

In Step S104, the CPU 21 receives an operation position on the first operation screen corresponding to an operation position of the operation of the user on the second operation screen received in Step S103, as the second reception unit 40.

In Step S105, the CPU 11 receives the operation position of the operation of the user on the second operation screen received by the user terminal 20 in Step S104 as the operation on the first operation screen, as the first reception unit 30.

As described above, with the information processing system 1 according to the exemplary embodiment, since the user performs an operation on the user terminal 20 near the processing apparatus 10 while capturing the first operation screen by the imaging unit 29, another user easily recognize that the processing apparatus 10 is in use. In addition, since the user performs an operation on the processing apparatus 10 on the second operation screen displayed on the user terminal 20 as the operation to the processing apparatus 10, in operating the processing apparatus 10, the user is prevented from directly touching the display unit 17 provided in the processing apparatus 10.

In the exemplary embodiment, in the user terminal 20, the display of the second operation screen reflecting the first operation screen may be fixed, and the second operation screen may be updated with the first operation screen newly reflected at every given time.

For example, in capturing the first operation screen by the user terminal 20, there is a case where the first operation screen is hardly captured clearly depending on the function of the imaging unit 29 of the user terminal 20 and the size of the display unit 27 of the user terminal 20. Alternatively, in capturing the first operation screen, there is a case where a phenomenon, such as so-called camera shake or out of focus, occurs and the first operation screen is hardly captured clearly. In regard to an operation on the second operation screen based on the first operation screen captured unclearly, an erroneous operation is likely to occur.

The second display unit 41 in the information processing system 1 according to the exemplary embodiment may fix the display of the second operation screen for a given time after imaging by the imaging unit 29 is completed in the user terminal 20 in such a manner that all marks displayed at the four corners of the first operation screen are included on the display unit 27.

Fixing of the display of the second operation screen may be updated at every given time, and for the given time for which the display of the second operation screen is fixed, the second operation screen on the display unit 27 of the user terminal 20 is not moved even though the user moves the user terminal 20.

In the exemplary embodiment, in a case where an operation on the second operation screen of the user terminal 20 reflecting the first operation screen is not performed within a predetermined time, the update of the display of the second operation screen may be stopped.

In a state in which the user captures the first operation screen by the user terminal 20, and in a case where the second reception unit 40 does not receive an operation of the user on the second operation screen within a predetermined time, the second display unit 41 may stop the update of the display of the second operation screen.

In the exemplary embodiment, in a case where the first operation screen is reflected in a state of being inclined and the second operation screen is not in a rectangular shape, the second operation screen may be displayed after being corrected to a rectangular shape.

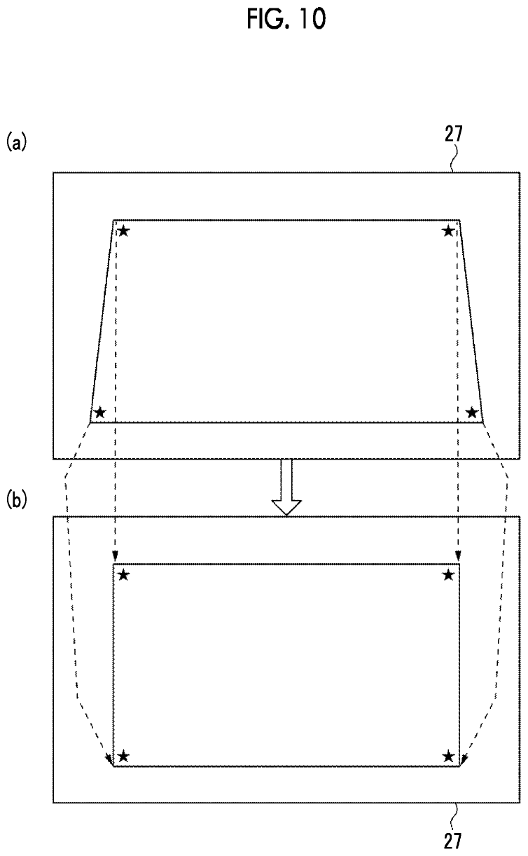

FIG. 10 is a diagram showing an example of correcting the shape of the second operation screen. There is a case where the first operation screen is reflected in a state of being inclined depending on an imaging state and an imaging angle of the first operation screen by the user terminal 20, and as shown in a part (a) of FIG. 10, the first operation screen is captured in a trapezoidal shape and received. In regard to an operation on the second operation screen based on the first operation screen captured unclearly, an erroneous operation is likely to occur.

Accordingly, in a case shown in the part (a) of FIG. 10, the second reception unit 40 specifies the coordinate positions of the marks displayed at the four corners of the first operation screen captured by the imaging unit 29 and receives that the coordinate position of each of the marks displayed at the four corners is not a coordinate position within a predetermined appropriate range. The second display unit 41 adjusts the value of the coordinate position of each of the marks displayed at the four corners received by the second reception unit 40, as shown in a part (b) of FIG. 10, corrects the second operation screen in a rectangular shape, and displays the second operation screen on the display unit 27. Even when the display of the second operation screen is corrected by the second display unit 41, the second communication unit 42 calculates an operation position from a ratio of a coordinate position caused by correction and transmits the operation position on the first operation screen.

In the exemplary embodiment, even in a case where the region of the second operation screen is smaller than the size of the screen of the display unit 27 on which the second operation screen is displayed, the operation position on the first operation screen corresponding to the operation position of the operation on the second operation screen may be received.

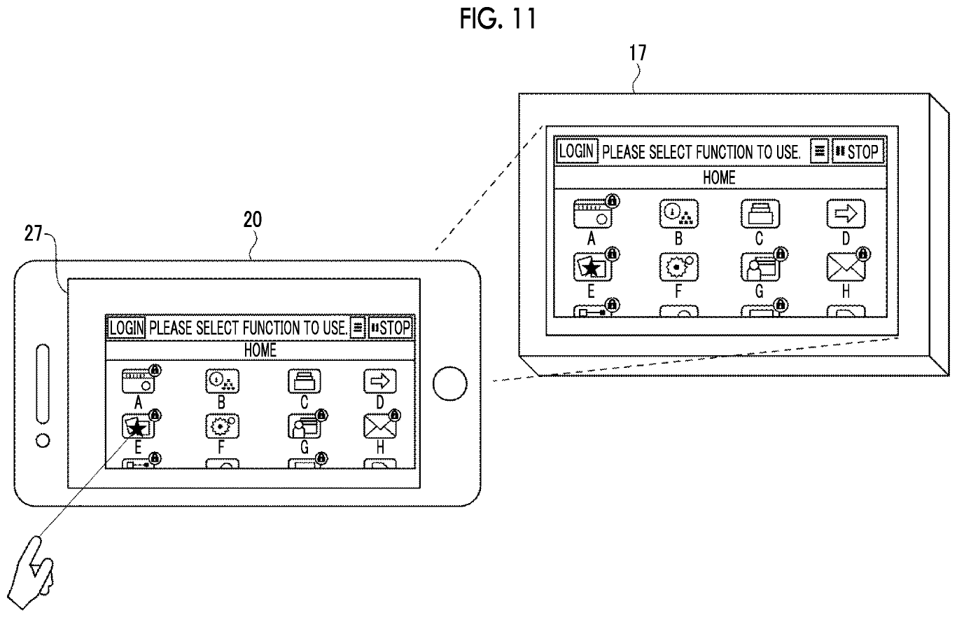

FIG. 11 is a diagram showing another example of the second operation screen reflecting the first operation screen. As shown in FIG. 11, there is a case where the region of the second operation screen is smaller than the size of the screen of the display unit 27 on which the second operation screen is displayed, depending on an imaging state and an imaging angle of the first operation screen by the user terminal 20. As shown in FIG. 11, for example, the user taps the icon of the function name “E” on the second operation screen displayed smaller than the size of the screen of the display unit 27. The second reception unit 40 receives a position tapped by the user from coordinates of the second operation screen displayed on the display unit 27 as coordinates.

In FIG. 11, for example, it is assumed that the size of the second operation screen is (0,0) to (960,480) in a coordinate region, and an operation position of the user indicated by a star symbol is a position of (50,100) in coordinates with the panel origin as a starting point. The second communication unit 42 calculates a ratio of coordinates to receive the operation position on the first operation screen corresponding to the operation position of the operation on the second operation screen. Specifically, the second communication unit 42 calculates (50/960,100/480) as the ratio of the coordinates, applies the ratio of the coordinates to the size of the first operation screen, and transmits a result as the operation position on the first operation screen corresponding to the operation position of the operation on the second operation screen. In FIG. 11, in a case where the size of the first operation screen is (1600,800) in coordinates, the second communication unit 42 calculates the ratio (50/960,100/480) of the coordinates on the second operation screen, that is, (0.520,0.208). As a result of calculation (1600*0.520,800*0.208) by the ratio of the coordinates, the second communication unit 42 transmits that an icon of a function positioned in about (500,200) on the first operation screen is tapped, to the processing apparatus 10. In FIG. 11, the icon of the function name “E” is present in the coordinates (500,200) of the first operation screen. Accordingly, the first reception unit 30 receives the icon of the function name “E” as the operation position on the first operation screen like the icon on the second operation screen.

In the exemplary embodiment, in a case where the region of the actually displayed second operation screen is smaller than the size of the screen of the display unit 27 on which the second operation screen is displayed by the second display unit 41, the second display unit 41 may cut the region of the second operation screen and may enlarge and display the second operation screen in conformity with the screen of the display unit 27.

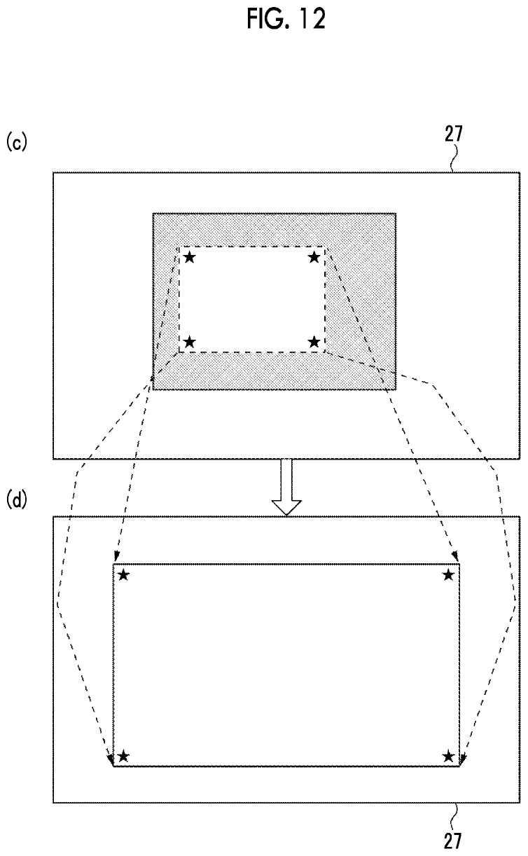

FIG. 12 is a diagram showing an example of trimming the second operation screen. As shown in a gray portion of a part (c) of FIG. 12, there is a case where a portion of the processing apparatus 10 other than the first operation screen is also captured depending on the function of the imaging unit 29 or an imaging state. In a case where a portion of the processing apparatus 10 other than the first operation screen is also captured, as shown in the part (c) of FIG. 12, the second operation screen is of course displayed smaller than the size of the screen of the display unit 27. The second reception unit 40 receives a rectangular shape formed by connecting the marks displayed at the four corners of the captured first operation screen by lines as the whole of the first operation screen and receives an outside of a frame of the whole (rectangular shape) of the first operation screen on an imaging screen as information unnecessary for display. As shown in a part (d) of FIG. 12, the second display unit 41 trims a portion outside the frame of the whole (rectangular shape) of the first operation screen received by the second reception unit 40, that is, the gray portion of the part (c) of FIG. 12 and displays only the first operation screen on the display unit 27.

In displaying only the first operation screen that is the inside of the rectangular frame formed by connecting the captured marks by lines, on the display unit 27, the second display unit 41 may enlarge and display the second operation screen in conformity with the size of the screen of the display unit 27. The second display unit 41 adjusts a coordinate position of each of the marks to conform to the size of the display unit 27 and enlarges and displays the whole first operation screen to be confined within the display screen of the display unit 27 while maintaining an aspect ratio of the first operation screen with the panel origin as a starting point. Even when the display of the second operation screen is enlarged by the second display unit 41, the second communication unit 42 calculates an operation position from an enlargement ratio of the display and transmits an operation position on the first operation screen.

In the exemplary embodiment, the second reception unit 40 may receive an instruction to enlarge and display a part of the second operation screen and may receive an operation on the enlarged and displayed second operation screen.

There is a case where the second operation screen is not displayed clearly depending on an imaging state and an imaging angle of the first operation screen by the user terminal 20. In regard to an operation on the second operation screen based on the first operation screen captured unclearly, an erroneous operation is likely to occur.

The second reception unit 40 receives an instruction to enlarge and display a part of the second operation screen. The instruction to enlarge and display a part of the second operation screen is, for example, a pitch zoom operation by the user. The second reception unit 40 receives a pitch zoom operation of the user who narrows or widens touch sensation of fingers on the display unit 27 as a touch panel in a state of touching the touch panel with two fingers.

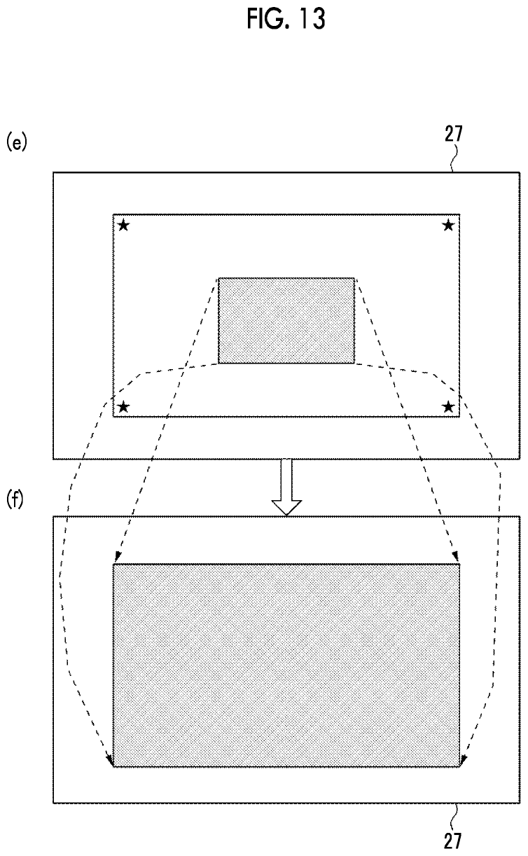

FIG. 13 is a diagram showing an example of enlarging the second operation screen. As shown in a part (e) of FIG. 13, there is a case where the user wants to enlarge and display only a certain specific range (in the part (e) of FIG. 13, a gray portion) on the second operation screen displayed on the display unit 27. The second reception unit 40 receives an operation of the user on the enlarged and displayed second operation screen.

As shown in a part (f) of FIG. 13, when the second display unit 41 enlarges and displays the specific range of the second operation screen, the second reception unit 40 receives an operation of the user within the enlarged specific range. The second reception unit 40 receives coordinate information of an operation position of the operation of the user calculated from actual coordinates of the second operation screen and an enlargement ratio of the display based on coordinate information of the second operation screen in a state of being captured by the imaging unit 29. Even when the display of the second operation screen is enlarged by the second display unit 41, the second communication unit 42 calculates an operation position from an enlargement ratio of the display and transmits an operation position on the first operation screen.

In the exemplary embodiment, although a form in which the information processing program is installed on the storage unit 13 and the storage unit 23, the present invention is not limited thereto. The information processing program according to the exemplary embodiment may be provided in a form of being recorded on a computer readable storage medium. For example, the information processing program according to the exemplary embodiment may be provided in a form of being recorded on an optical disc, such as a compact disc (CD)-ROM or a digital versatile disc (DVD)-ROM, or in a form of being recorded in a semiconductor memory, such as a universal serial bus (USB) memory or a memory card. Alternatively, the information processing program according to the exemplary embodiment may be acquired from an external apparatus through a communication line connected to the communication I/F 14 and the communication I/F 24.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a user terminal including an imaging unit; and
a processing apparatus that is operable by the user terminal,
wherein the processing apparatus includes a first processor,
the user terminal includes a second processor,
the first processor is configured to:
display a first operation screen for operating the processing apparatus on a screen of the processing apparatus,
the second processor is configured to:
receive an operation on a second operation screen of the user terminal reflecting the first operation screen captured by the imaging unit, and
transmit an operation position on the first operation screen corresponding to an operation position of the received operation to the processing apparatus, and
the first processor is configured to:
receive the received operation position as an operation on the first operation screen.

2. The information processing system according to claim 1, wherein the second processor is configured to:
fix the second operation screen reflecting the first operation screen and update the second operation screen with the first operation screen newly reflected at each given time.

3. The information processing system according to claim 2, wherein the second processor is configured to:
stop the update of display of the second operation screen in a case where the operation on the second operation screen of the user terminal reflecting the first operation screen is not performed within a predetermined time.

4. The information processing system according to claim 1, wherein the second processor is configured to:
display the second operation screen after correcting the second operation screen to a rectangular shape in a case where the first operation screen is reflected in a state of being inclined and the second operation screen is not in a rectangular shape.

5. The information processing system according to claim 2, wherein the second processor is configured to:
display the second operation screen after correcting the second operation screen to a rectangular shape in a case where the first operation screen is reflected in a state of being inclined and the second operation screen is not in a rectangular shape.

6. The information processing system according to claim 3, wherein the second processor is configured to:
display the second operation screen after correcting the second operation screen to a rectangular shape in a case where the first operation screen is reflected in a state of being inclined and the second operation screen is not in a rectangular shape.

7. The information processing system according to claim 1, wherein the second processor is configured to:
in a case where a region of the displayed second operation screen is smaller than a size of a screen of a display unit that displays the second operation screen, cut the region of the second operation screen and enlarge and display the second operation screen in conformity with a size of the screen of the display unit.

8. The information processing system according to claim 2, wherein the second processor is configured to:
in a case where a region of the displayed second operation screen is smaller than a size of a screen of a display unit that displays the second operation screen, cut the region of the second operation screen and enlarge and display the second operation screen in conformity with a size of the screen of the display unit.

9. The information processing system according to claim 3, wherein the second processor is configured to:
in a case where a region of the displayed second operation screen is smaller than a size of a screen of a display unit that displays the second operation screen, cut the region of the second operation screen and enlarge and display the second operation screen in conformity with a size of the screen of the display unit.

10. The information processing system according to claim 4, wherein the second processor is configured to:
in a case where a region of the displayed second operation screen is smaller than a size of a screen of a display unit that displays the second operation screen, cut the region of the second operation screen and enlarge and display the second operation screen in conformity with a size of the screen of the display unit.

11. The information processing system according to claim 5, wherein the second processor is configured to:
in a case where a region of the displayed second operation screen is smaller than a size of a screen of a display unit that displays the second operation screen, cut the region of the second operation screen and enlarge and display the second operation screen in conformity with a size of the screen of the display unit.

12. The information processing system according to claim 6, wherein the second processor is configured to:
in a case where a region of the displayed second operation screen is smaller than a size of a screen of a display unit that displays the second operation screen, cut the region of the second operation screen and enlarge and display the second operation screen in conformity with a size of the screen of the display unit.

13. The information processing system according to claim 1, wherein the second processor is configured to:
receive an instruction to enlarge and display a part of the second operation screen and receive an operation on the enlarged second operation screen.

14. The information processing system according to claim 2, wherein the second processor is configured to:
receive an instruction to enlarge and display a part of the second operation screen and receive an operation on the enlarged second operation screen.

15. The information processing system according to claim 3, wherein the second processor is configured to:
receive an instruction to enlarge and display a part of the second operation screen and receive an operation on the enlarged second operation screen.

16. The information processing system according to claim 4, wherein the second processor is configured to:
receive an instruction to enlarge and display a part of the second operation screen and receive an operation on the enlarged second operation screen.

17. The information processing system according to claim 5, wherein the second processor is configured to:
receive an instruction to enlarge and display a part of the second operation screen and receive an operation on the enlarged second operation screen.

18. The information processing system according to claim 6, wherein the second processor is configured to:
receive an instruction to enlarge and display a part of the second operation screen and receive an operation on the enlarged second operation screen.

19. An information processing apparatus comprising:
a processor configured to:
display a first operation screen,
acquire an operation position on the first operation screen corresponding to an operation position on a second operation screen of a user terminal reflecting the first operation screen, and
receive the operation position on the second operation screen as an operation on the first operation screen.

20. A non-transitory computer readable medium storing an information processing program causing a computer to execute a process comprising:
displaying a first operation screen;
acquiring an operation position on the first operation screen corresponding to an operation position on a second operation screen of a user terminal reflecting the first operation screen; and
receiving the operation position on the second operation screen as an operation on the first operation screen.
